(19) United States
(12) Patent Application Publication
(10) Pub. No.: US 2024/0003397 A1
(43) Pub. Date: Jan. 4, 2024

(54) Energy Absorption Member

(71) Applicant: Zephyros, Inc., Romeo, MI (US)

(72) Inventors: Amar Ali-Larnene, Molsheim Cedex (FR); Peter Cate, Gloucestershire (GB)

(21) Appl. No.: 18/034,937

(22) PCT Filed: Oct. 26, 2021
(86) PCT No.: PCT/EP2021/079650

§ 371 Date: May 2, 2023

(30) Foreign Application Priority Data
Nov. 4, 2020 (EP) 20205664.4
Nov. 9, 2020 (EP) 20206515.7
Nov. 27, 2020 (EP) 20210220.8
Mar. 2, 2021 (EP) 21160220.6
Jun. 28, 2021 (EP) 21181999.0

(51) Int. Cl. F16F 7/12

(52) U.S. Cl. CPC F16F 7/125

(57) ABSTRACT

The present invention relates to a member to absorb energy, particularly impact-energy. The present invention further relates to a structure comprising the member and a method to absorb energy, particularly impact energy.

The present invention relates to a member to absorb energy, particularly impact-energy. The present invention further relates to a structure comprising the member and a method to absorb energy, particularly impact energy.

There is a constant need in the industry, particularly in the automotive industry, to provide members which absorb energy, particularly impact energy, in order to protect the passengers and certain elements of a vehicle and/or a structure.

The problem is attained with a member to absorb energy, particularly impact-energy, wherein it comprises at least a first layer and a second layer, each layer comprising a multitude of interconnected three-dimensional elements and/or openings, wherein for energy dissipation:
the three-dimensional elements of the first layer are inserted into the three-dimensional elements, of the second layer and/or the openings and/or vice versa and/or
the three-dimensional elements, of the first layer are inserted into a hollow space provided between two or more three-dimensional elements of the second layer or vice versa.

The disclosure regarding this subject matter also applies to the other subject matters and vice versa. Subject matters disclosed regarding this embodiment of the invention can also be included in other embodiments and vice versa.

The present invention relates to a member to absorb energy, particularly impact-energy, preferably made from a polymeric material, more preferably nylon and/or a preferably a metal material, for example aluminum or steel. According to a preferred embodiment, the member is made of a composite material, preferably comprising multiple polymeric materials and/or a combination of one or more plastic materials and one or more metal materials. The member comprises at least a first and a second layer. However, the member may comprise more than two layers, particularly four, six or eight layers. Preferred is an even or uneven number of layers. More preferred, two layers of the member, whose three-dimensional elements are inserted into each other, form one assembled unit. Preferably, the member comprises at least, preferably more of those units. Each layer comprises a multitude of interconnected three-dimensional elements. The three-dimensional elements and/or the openings are preferably interconnected by a interconnecting-layer. This interconnecting-layer can be of the same or a different material than the three-dimensional elements. The openings can be provided in this layer. Preferably, the three-dimensional elements comprise a rim or flange and the rims/flanges form the interconnecting layer. One end of each three-dimensional elements may be provided in a plane and the rest of each three-dimensional elements extends out of this plane. The three-dimensional elements are preferably hollow structures. The skilled person understands, that the plane need not be flat, but can be three-dimensional, for example curved.

According to the invention, the three-dimensional elements and/or the openings are now designed such, that for energy dissipation:
the three-dimensional elements of the first layer are inserted into the three-dimensional elements and/or the openings, of the second layer and/or vice versa
the three-dimensional elements, of the first layer are inserted into a hollow space provided between two or more three-dimensional elements of the second layer and/or vice versa.

During the insertion of the three-dimensional elements of one layer into or in between the three-dimensional elements of the adjacent layer and/or into the openings, friction between the three-dimensional elements of the two layers and/or elastic- and/or plastic deformation and/or tangential stress of the three-dimensional elements and/or the openings of at least one of layers, preferably both layers, takes place, so that energy, particularly impact energy is dissipated. During the plastic deformation, preferably the cross section of three-dimensional elements and/or the openings of at least one layer is reversibly and/or irreversibly increased and/or decreased and/or the axial extension of the three-dimensional elements of one or both layers is reversibly and/or irreversibly reduced.

The three-dimensional elements and/or the openings of each layer are interconnected, for example according to a constant and/or non-constant pattern, preferably a constant matrix. The three-dimensional elements and/or the openings of one layer can be spaced equidistantly.

At least one layer can be part of the structure of the vehicle, for example part of the body in white. This layer preferably comprises one or more openings into which three-dimensional elements are inserted.

The layers of one member may be identical or different. Preferably, the layers are staggered.

Preferably, the three-dimensional elements are hollow elements.

The three-dimensional elements preferably have a circular, an oval and/or a polygonal cross-section. The shape of the cross section may vary with the axial extension of the three-dimensional elements. One layer may have three-dimensional elements with different cross sections and/or different axial lengths. Preferably, the three-dimensional elements are tapered, preferably with a larger or the largest cross section in the plane in which the three-dimensional elements are interconnected. In case the three-dimensional elements are tapered, the angel of inclination may be constant around their entire circumference or not. The angel of inclination may further vary with the axial length of the three-dimensional element. The sidewall of the one or more three-dimensional element(s) of one layer may include one or more step(s). In case the sidewall is made of a laminate, not all layers of the laminate need to comprise the step(s).

Preferably the shape and/or the size of the cross-section of the three-dimensional elements, the axial extension, the length of the three-dimensional elements, the inclination of the sidewall and/or the pattern, which they are distributed over the plane of two adjacent layers differ within one layer or between two adjacent layers.

Preferably, the three-dimensional elements of the layers each have a sidewall and the sidewall of the three-dimensional elements of the first layer has, at least locally, a different shape and/or size than the sidewall of the three-dimensional elements of the second layer.

Each opening may have a circular, an oval and/or a polygonal cross-section.

Preferably at least one of the first or second layer comprises connecting means. Via these connecting means, for example an adhesive layer, the layer can be connected to a structure, for example the structure of a vehicle and/or two or more layers can be connected by connection means, preferably an adhesive layer.

Each adhesive layer is preferably applied after the three-dimensional layer has been formed or the adhesive layer is part of the material of three-dimensional layer, for example an adhesive layer.

Two layers can also be connected to each other by connection means prior to an impact or an energy absorption. These connection means can be for example an adhesive, e.g. an adhesive layer, a friction- form- and/or fore-fit, for example a snap-fit.

Two layers, particularly the first- and the second layer can be provided as a single piece, preferably as one moulded-piece.

According to another preferred embodiment of the present invention, the thickness of the sidewall of the three-dimensional elements of at least one layer is not constant.

Preferably, the three-dimensional elements of at least one layer comprise a reinforcement element. This reinforcement element, for example one or more rib(s) and/or a foam-layer, preferably structural-foam, is preferably provided in the hollow section of the three-dimensional element and/or between the three-dimensional elements. The reinforcement elements can be provided within the structure of the three-dimensional elements and/or adjacent to the three-dimensional elements.

Another subject matter of the present invention is a system comprising a structure and the inventive member.

The disclosure regarding this subject matter also applies to the other subject matters and vice versa. Subject matters disclosed regarding this embodiment of the invention can also be included in other embodiments and vice versa.

The structure can be any structure for example a crash barrier or a body armour or a vehicle The structure may be a metal- and/or a plastic-structure. The inventive member is provided at or in the structure to reduce its deformation for example during an impact. Preferably, the structure comprises a cavity in which the member is located. More preferably, at least one layer of the member is attached to the structure. Additionally or alternatively, the inventive member can be provided at a structure without a cavity.

The layer of the member can be moulded as one single part. Other methods to produce the layers are, for example, pultrusion, injection molding and/or thermoforming and/or compression molding, and/or blow moulding.

The problem is also solved with a method to absorb energy, particularly impact energy, with, the inventive member, wherein the three-dimensional structures and/or the openings of the two layers are moved relative to one another, whereby friction between the three-dimensional elements and/or the openings of the two layers takes place and the three dimensional elements and/or the openings of at least one layer are deformed plastically.

The disclosure regarding this subject matter also applies to the other subject matters and vice versa. Subject matters disclosed regarding this embodiment of the invention can also be included in other embodiments and vice versa.

According to this subject matter of the present invention the two layers and their three-dimensional elements and/or openings are moved relative to one another during an impact, so that the three-dimensional elements and/or the openings of the two layers get in contact with each other or the contact- or overlap-area is increased. Due to this contact, friction and plastic deformation and/or tangential stress takes place, while the two layers move relative to each other. The friction and the elastic- and/or plastic deformation and/or the tangential stress dissipate(s) energy, which reduces the deformation of the structure at which or in which the inventive member is provided.

Preferably, the three-dimensional elements and/or the openings are reversibly and/or irreversibly expanded and/or reversibly and/or irreversibly compressed and/or reversibly and/or irreversibly tangentially stressed. More preferably, the three-dimensional elements of the first layer are reversibly and/or irreversibly compressed in their cross-section and optionally in their axial extension, while the three-dimensional elements and/or the openings of the second layer are reversibly and/or irreversibly increased in their cross-section and optionally reversibly and/or irreversibly compressed in their axial extension.

Preferably, the three-dimensional elements of the first layer are inserted into and/or between the three-dimensional elements of the second layer. More preferably, one three-dimensional element of the first layer is inserted into one three-dimensional element of the second layer. More preferably, three-dimensional elements of the first layer are inserted between at least two, preferably three, four or more than four three-dimensional elements of the second layer.

Preferably, the three dimensional elements of two layers interlock during their plastic deformation.

In the following the inventions are explained according to the figures. These explanations do not limit the scope of protection. The explanations apply to all embodiments of the present invention likewise.

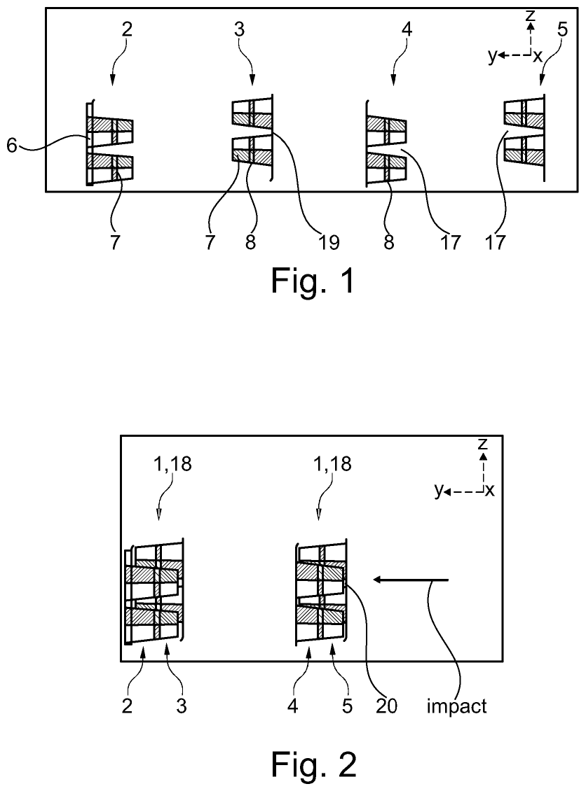

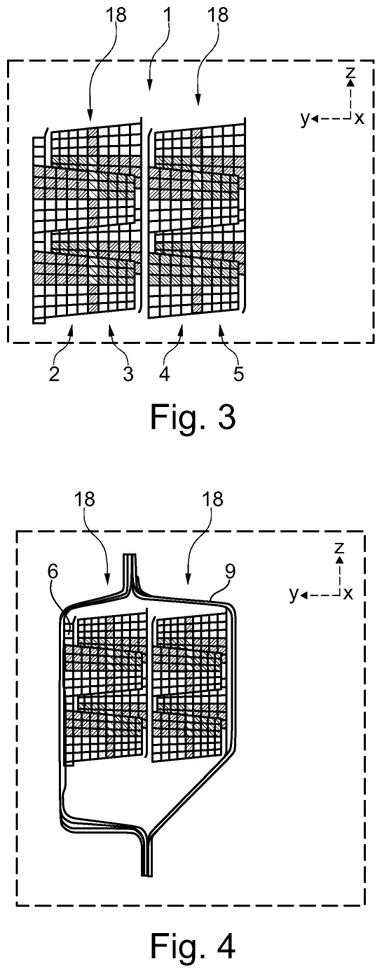

FIGS. 1-3 shows an embodiment of the inventive member and its production.

FIG. 4 the inventive structure.

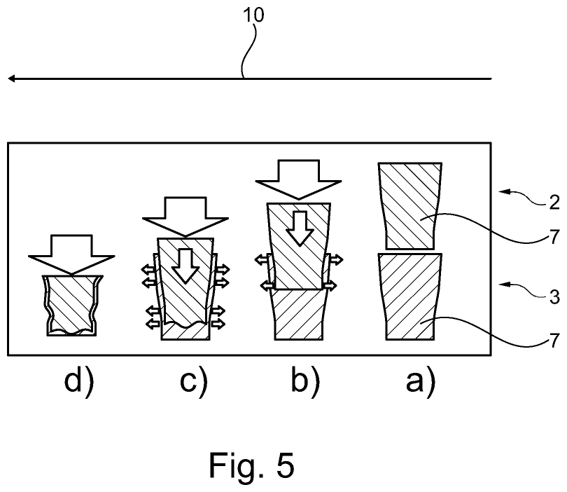

FIG. 5 depicts an embodiment of the inventive method.

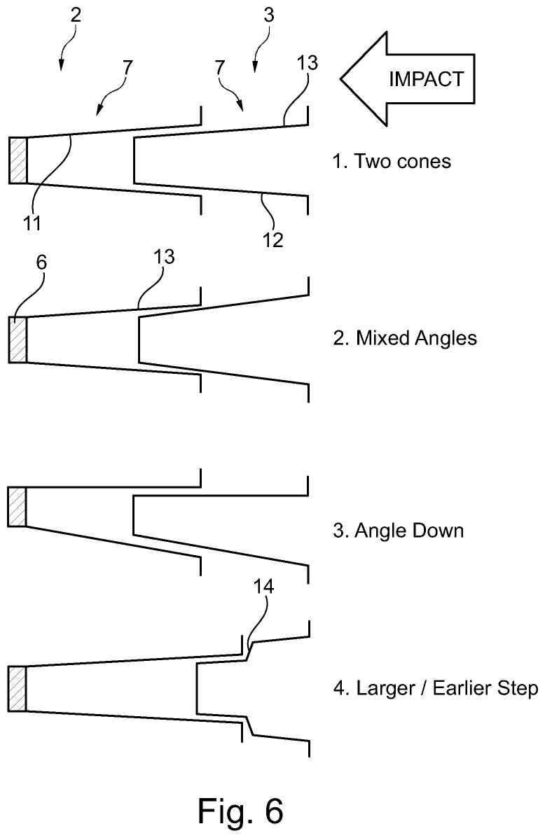

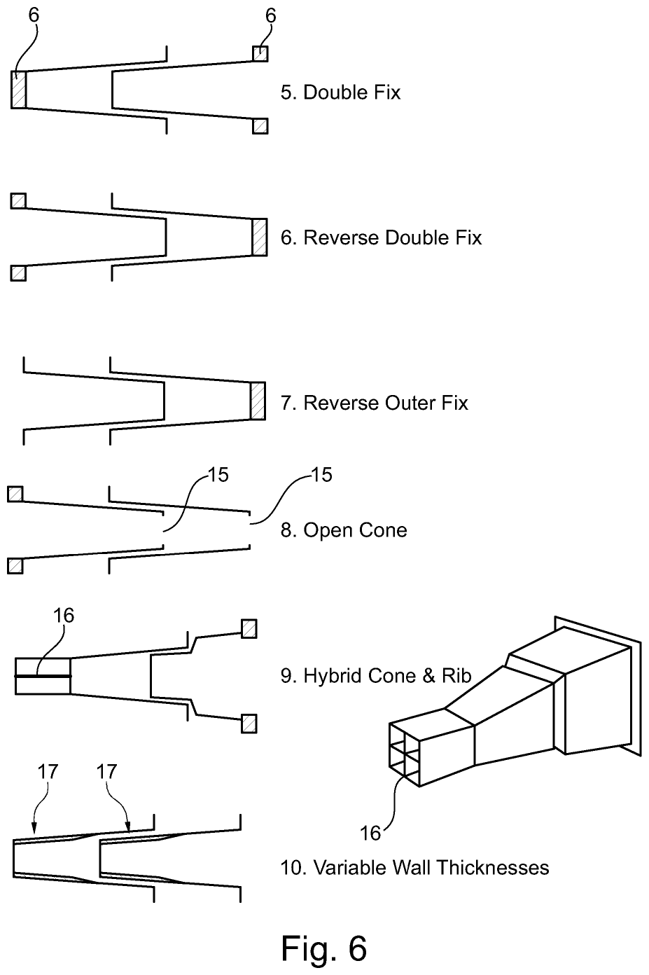

FIG. 6 shows ten different embodiments of the three dimensional elements.

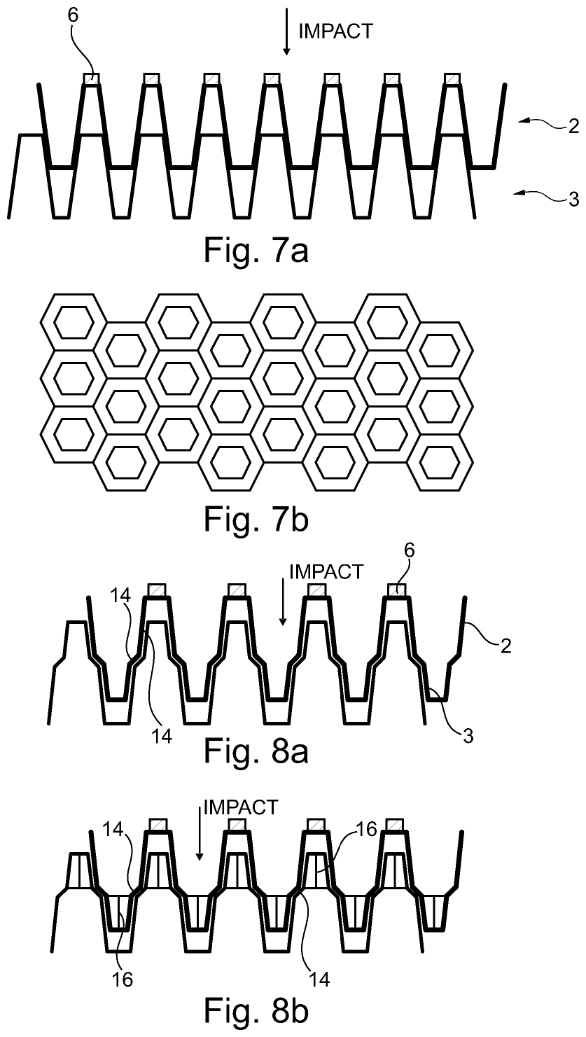

FIGS. 7a and b and 8a and b show different embodiments of the first and the second layer.

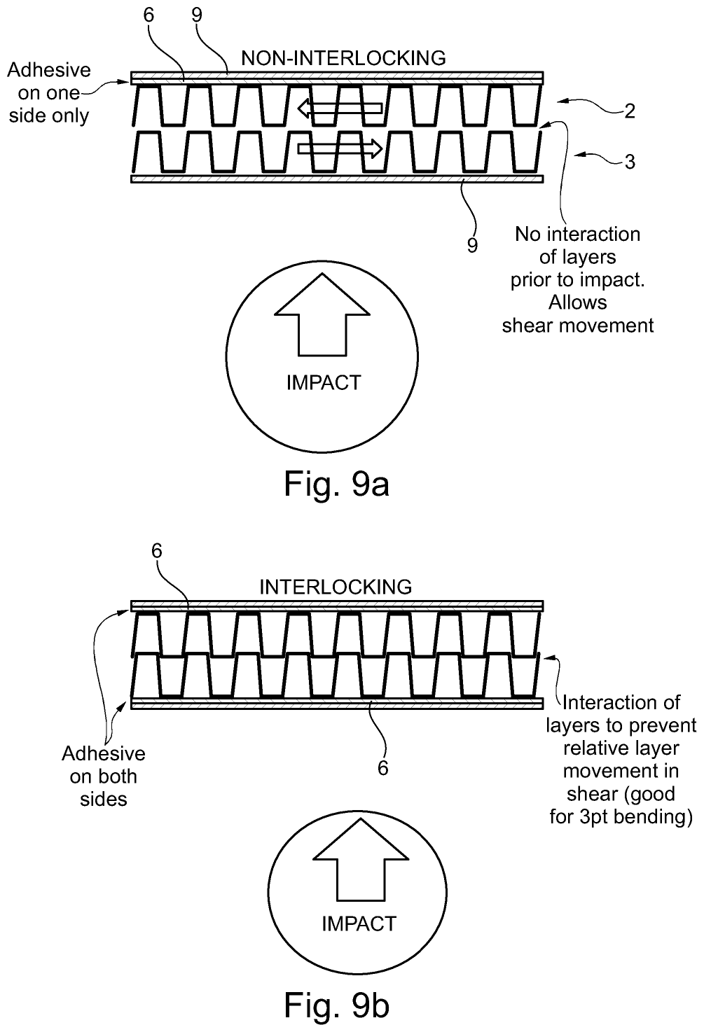

FIGS. 9a and b show different embodiments of inventive system.

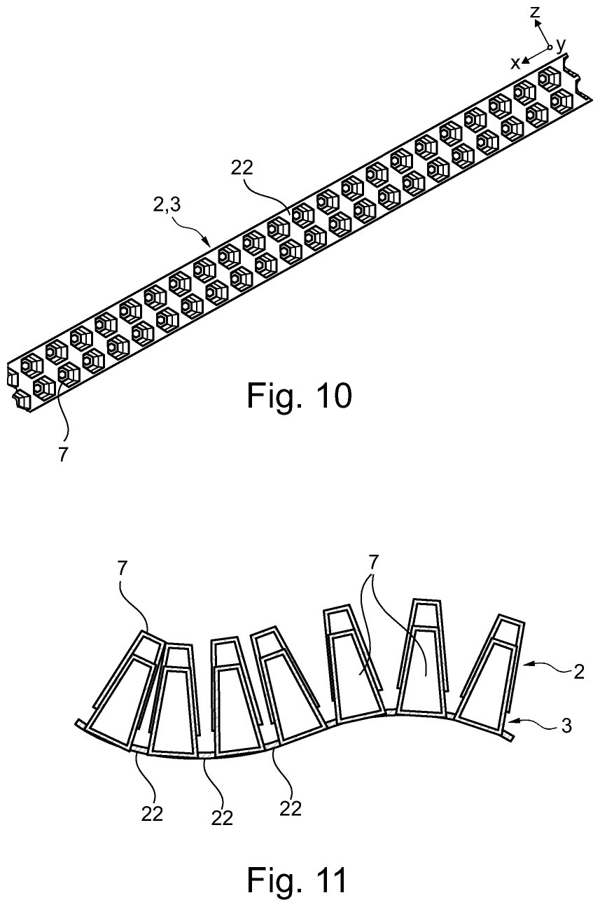

FIG. 10 shows one layer of the inventive member

FIG. 11 shows an embodiment of the member wherein the connection between the three-dimensional elements is flexible.

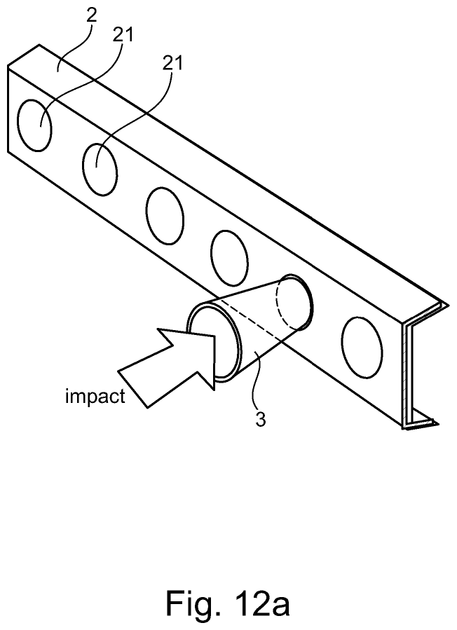

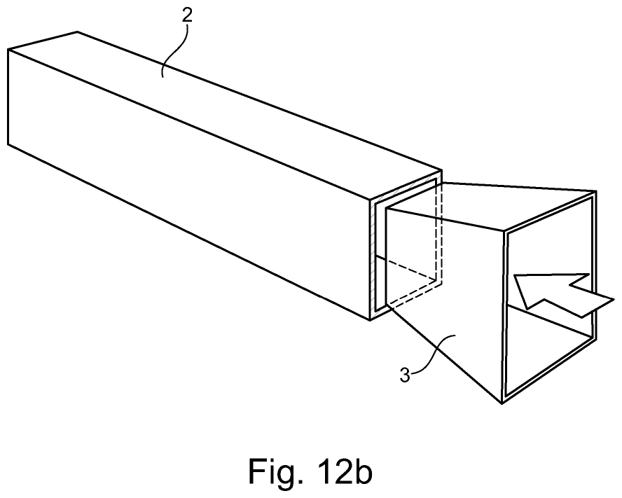

FIGS. 12a and b each depict an example with openings in one layer.

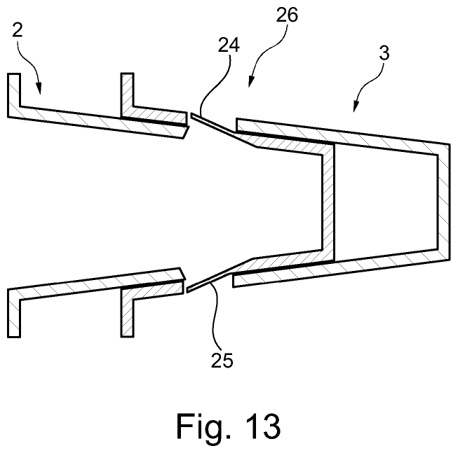

FIG. 13 shows a snap-fit as connection means between two layers.

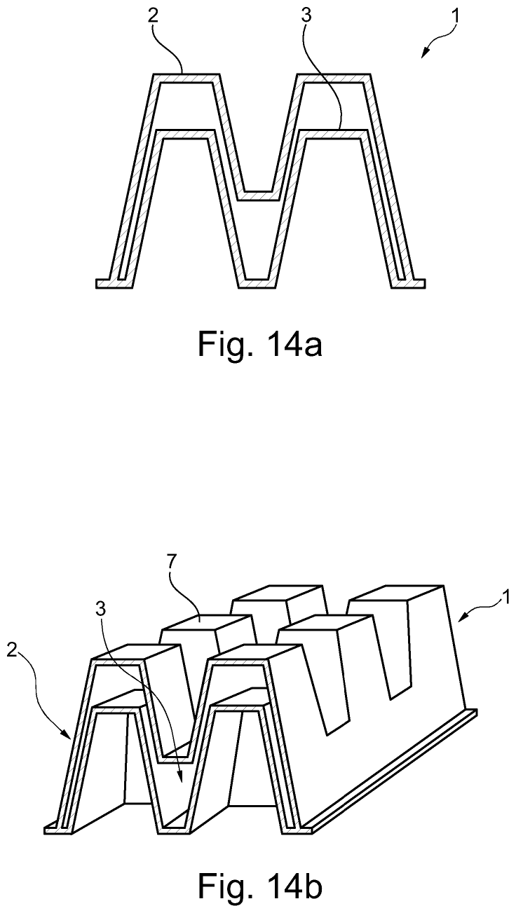

FIGS. 14a, b show a blow-moulded part.

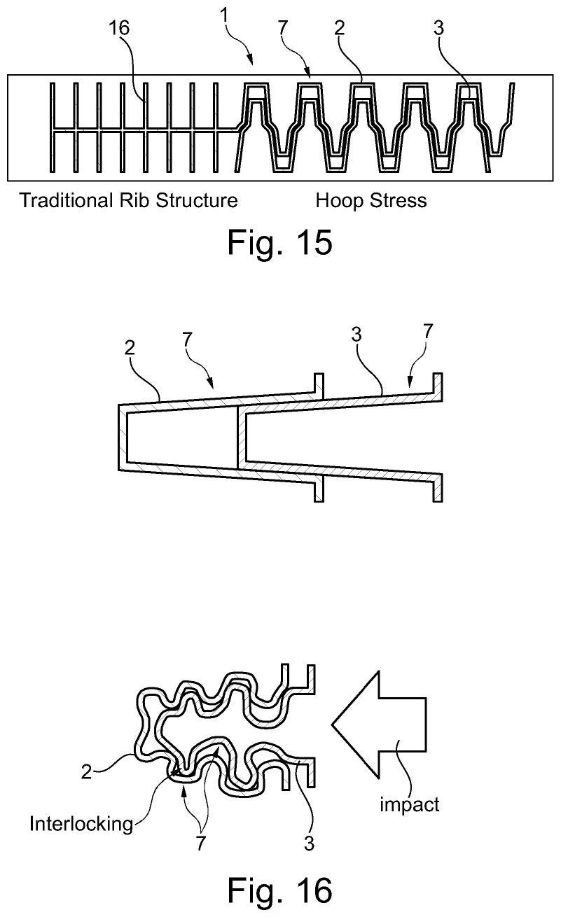

FIG. 15 show an inventive embodiment, wherein one layer comprises reinforcement elements

FIG. 16 shows two three dimensional elements which interlock during their relative movement.

All embodiments, except FIG. 5, depicted below show the member prior to an impact, respectively.

FIGS. 1-3 show a first embodiment of the inventive member, which comprises at least a first layer 2 and a second layer 3, here optionally also a third 4 and a fourth layer 5, wherein layer 4 is preferably identical to layer 2 and layer 5 is preferably identical to layer 3 or all layers are identical. As can be seen for example from FIG. 2, the first- and the second layer 2, 3 and the third- and the fourth layer 4, 5 each form a unit 18. Each layer 2-5 comprises a multitude of three-dimensional elements 7, which are interconnected, here at a base 19. The base of each layer 2, 3 is here provided at the outer circumference of each unit 18. In the present case the three-dimensional elements of all layers are shaped essentially as a truncated cone, with an axial extension that is perpendicular to the base 19. In the present example, the three-dimensional elements 7 of one layer 2 are provided with a space 17 in between two adjacent three-dimensional elements 7. In the present case, the layers 2-5 are identical and each unit 18 comprising two layers 2, 3 or 4, 5 is here provided by interlocking two layers 2, 3 or 4, 5, in the present case such that each three-dimensional element of one layer 2 is provided in between at least two three-dimensional elements of the other layer 3 and vice versa, such that, at least locally, the outer circumference of one three-dimensional element of one layer 2 is in contact with the outer circumference of at least two or more three-dimensional elements of the adjacent layer 3 and vice versa. However, as can be seen particularly from FIG. 2, a space 20 is provided between two interlocked layers prior to an impact. For absorbing energy, the two layers of one unit 18 will be moved together as indicated by the arrow “impact”. This reduces space 20 at least partially and causes friction between the three-dimensional elements of the two layers 2, 3 and in combination with plastic deformation of the three-dimensional elements of at least one layer 2, 3 impact-energy is dissipated. Before the plastic deformation takes place, the three-dimensional elements of at least one layer 2, 3 are preferably deformed elastically. One or more layers, here layer 2 may comprise connection means 6, here an adhesive layer, to connect the member 1 or one unit 18 of a member 1 to a structure as depicted in FIG. 4.

In the present case, the three-dimensional elements 7 are depicted all identically. However, the skilled person understands, that each layer 2-5 may comprise differently shaped and/or sized three-dimensional elements. The skilled person also understands the three-dimensional elements of two adjacent interacting layers can be different.

The three-dimensional elements 7 are per layer preferably provided as an array of three-dimensional elements 7. The three-dimensional elements 7 are preferably arranged equidistantly.

The three-dimensional elements 7 are preferably hollow. The three-dimensional elements 7 may be closed or partially closed at the end facing away from the base 19, i.e. the bottom of the three-dimensional elements 7. At the base, the three-dimensional elements 7 may be open or partially or totally closed.

In the example according to FIGS. 1-3, the inclination of the sidewall of the truncated cone is not constant and comprises here two steps. With the variation of the inclination the degree and the location of the friction and/or the deformation can be adjusted to the desired energy dissipation.

FIG. 4 shows the inventive system. The structure 9, comprises in the present case comprises the layers 2-5 or two units 18 according to FIGS. 1-3, here provided in a cavity of the structure 9. However, the skilled person understands that there may be less or more layers 2-5 or less or more units 18. The skilled person further understands that the three-dimensional elements 7 or one or all layers of one unit may be shaped differently.

In the present case, one unit comprising two layers and here the unit on the left hand side is attached to the structure 9. However, both units 18 can be connected to the structure. The units 18 are stacked side by side, here in the horizontal direction.

The structure is here the structure of a vehicle. The skilled person understands that the structure can be any structure for example a crash barrier or a body armour.

The three-dimensional elements 7 of each layer are preferably provided such, that their axial extension is parallel or at least essentially parallel to the expected energy input, for example due to an impact.

FIG. 5 depicts the inventive method. In the present case, the three-dimensional elements 7 of the first layer 2 are not inserted into a space 17 in between two adjacent three-dimensional elements 7 of the adjacent second layer, but into the three-dimensional elements 7 of the adjacent layer. The three-dimensional elements 7 are here depicted as truncated cones, but the skilled person understands that the explanations according to FIG. 5 are not restricted to this shape.

The timeline is depicted by an arrow with the reference number 10. Four different states a)—d) are depicted. State a) is the initial state. The three-dimensional elements 7 of the adjacent layers 2, 3 are here spaced apart as depicted. In state b) the impact and the energy absorption starts by sliding the three-dimensional elements 7 of layer 2 into the three-dimensional elements 7 of layer 3. This causes friction between the sidewalls of the three-dimensional elements 7 and the elastic and/or plastic deformation, particularly of the three-dimensional elements 7 in layer 3 starts, by increasing its cross section. The state c) depicts a progressed plastic deformation. The increase of the cross section has now progressed along the axial extension of the three-dimensional elements 7 of layer 3. The three-dimensional elements 7 have, as depicted, also been compressed. In state d), the axial extension of the three-dimensional elements 7 of both layers is compressed, preferably plastically compressed.

FIG. 6 show ten different embodiments of the shape of the three-dimensional elements 7. The examples all depict an embodiment in which three-dimensional elements 7 are inserted into each other. The skilled person understands that the depicted three-dimensional elements 7 can also be used for embodiments in which the three-dimensional elements 7 of one layer are inserted in between two or more three-dimensional elements 7 of the adjacent layer, as for example depicted in FIGS. 1-3. The skilled person further understands that prior to impact, there need not be an axial overlap between the two layers 2, 3. The impact direction, which is parallel or at least essentially parallel to the axial extension of the three-dimensional elements 7 is in all examples of FIG. 6 the same. “Impact” is here only a term which stands for any desired or undesired energy input, that needs to be dissipated.

The layers 2, 3 of all embodiments can be for example modeled, injection moulded or deep drawn. The two layers 2, 3 may be made of the same or different materials.

In all examples of FIG. 6 only two layers are shown, but the skilled person understands that there may be more than two layers, preferably a multitude of first and second layers. In FIG. 6 in all examples only one three-dimensional element 7 is depicted but it is understood that each layer may comprise a multitude of interconnected three-dimensional elements 7, preferably interconnected at their rim and/or provided as an array of three-dimensional elements 7.

The examples according to FIG. 6 illustrate, that the design of the three-dimensional elements 7 of the first- and the second layer allows a very precise adjustment of the energy dissipation, in terms of total amount of energy absorbed and/or the relative amount of energy absorbed by tangential stress, by friction and/or by crushing, preferably each as a function of time, as well as relative movement of the first- and the second layer relative to each other.

Embodiment 1. shows a first alternative of the present invention. In the present case, the three-dimensional elements 7 of the first and second layer 2, 3 are truncated cones, here each with a bottom. In the present case the two truncated cones may be identical. Prior to and/or during an impact, the truncated cone of the second layer 3 is inserted into the truncated cone of the first layer, whereby energy is dissipated by friction when surfaces 11, 12 slide along each other and/or by plastic deformation, particularly when the sidewall 13 of the three-dimensional elements 7 of one or both layers are compressed in when their axial extension and/or their cross-section is increased and/or decreased, respectively. In the present example, the first layer 2 comprises connection means 6 to connect it for example to a structure 9.

Embodiment 2. shows a second alternative of the present invention. In the present case, the three-dimensional elements 7 of the first and second layer 2, 3 are truncated cones, here each with a bottom. In the present case the two truncated cones of the two layers have different angels of inclination. Specifically, the angle of inclination of the truncated cone of the second layer 3 is larger than the angle of inclination of the truncated cone of the first layer 2. In comparison to the embodiment 1. this will lead to an earlier elastic and plastic deformation of the three-dimensional elements 7 of both layers 2, 3 and/or to an increased friction. Prior to and/or during an impact, the truncated cone of the second layer is inserted into the truncated cone of the first layer, whereby energy is dissipated by friction and/or by plastic deformation, particularly by widening and/or reducing the cross section of the three-dimensional elements 7 and/or when the three-dimensional elements 7 of one or both layers are compressed in their axial extension. In the present example, the first layer 2 comprises connection means 6 to connect it for example to a structure.

Embodiment 3. shows three-dimensional elements 7 which are tapered, so that essentially reference can be made to the description according to embodiments 1. and 2.. However, in the present case not the entire circumference of the three-dimensional elements 7 is tapered but only a portion of the circumference.

Regarding embodiment 4. reference is made to the disclosure regarding embodiments 1. and 2. but particularly to the embodiment 2.. In the present case, the three-dimensional elements 7 of the second layer 3 comprise a step 14 in the tapered structure. Due to this step 14, in comparison to the embodiment 2., the plastic deformation of the three-dimensional elements 7 of the first layer is more abrupt and in comparison to the embodiment 2. starts earlier, particularly in case the step 14 is provided near the tip/bottom of the three-dimensional elements 7, as it is depicted here.

Embodiment 5. is essentially embodiment 1., so that reference can be made to the disclosure of this embodiment. However, in the embodiment 5. both layers are provided with a connection layer 6. which allows the connection of both layers to a structure 9.

Embodiment 6. is essentially embodiment 5. so that reference can be made to the disclosure of this embodiment. In this embodiment 5 the orientation of the layers relative to the impact has been reversed.

Embodiment 7. is essentially embodiment 6. so that reference can be made to the disclosure of this embodiment, but the connection means at the first layer 2 have been omitted.

Embodiment 8. is essentially embodiments 6. or 7., so that reference can be made to the disclosure of these embodiments. In the present case, the three-dimensional elements 7 have a recess 15. Particularly, the bottom of the truncated cone has a recess.

In the embodiment 9., it is depicted that the three-dimensional elements 7 of one or both layers may comprise reinforcement means 16, here in the form of one or more ribs. The reinforcement means can for example avoid bucking of the three-dimensional elements 7 of one layer. Another aspect of this example is a tapered three-dimensional element 7 with a rectangular or square cross-section.

A changing wall thickness of the three-dimensional elements 7 of one or both layers 2, 3 is depicted in embodiment 10. of FIG. 6. The increased wall thickness of the three-dimensional elements 7 is preferably provided around the entire circumference of the three-dimensional elements 7. The increased wall thickness is preferably provided in an area in which elastic or plastic deformation is not desired and/or in which deformation shall take place late or latest.

FIG. 7 shows two views 7a and 7b of an embodiment wherein the three-dimensional elements 7 have a polygonal, here hexagonal diameter. The embodiment according to FIG. 7 is similar to the embodiment 2. according to FIG. 6, so that the disclosure made regarding this embodiment applies to this embodiment likewise.

FIG. 8a shows an embodiment of the present invention, that is similar to the embodiment 4. of FIG. 6, so that the disclosure made regarding this embodiment applies to this embodiment likewise. In the example according to FIG. 8a, the three-dimensional elements 7 of both layers 2, 3 have a step 14 in their sidewall, which are prior to an impact adjacent or in touch with each other.

FIG. 8b shows essentially the embodiment according to FIG. 8a, 6, so that the disclosure made regarding this embodiment applies to this embodiment likewise, wherein in the present case, the tip of the three-dimensional elements 7 comprise reinforcement means as described according to embodiment 9. of FIG. 6.

FIG. 9a shows another embodiment of the inventive system. A member 1 comprising two layers 2, 3 of the three-dimensional elements 7 is provided in the structure 9 of, for example, a vehicle. The layer 2 is connected to the structure 9 by connection means 6, here an adhesive layer, The other layer 3 is preferably not connected to the structure. As depicted by the space between the layers 2, 3 and the two, here horizontal arrows, prior to impact or energy absorption, the two layers 2, 3 can move relative to each other. After an impact, the two layers interlock.

FIG. 9b depicts a similar embodiment as the embodiment according to FIG. 9a, so that reference can be made to the disclosure regarding this embodiment. Here both layers 2, 3 are connected to the structure.

FIG. 10 depicts one layer 2, 3. It can be clearly seen that the three-dimensional elements 7 are interconnected by an interconnecting layer 22. In the present case the three-dimensional elements and the interconnecting layer 22 are made from the same material. In the present case, the depicted layer is produced by injection moulding into the layer shown. The skilled person understands, that the interconnecting layer may not be flat, but formed, for example curved.

FIG. 11 depicts an example in which the layers 2, 3 are not plane but curved. The curvature may be permanent or temporarily.

Reference is now made layer 3 of FIG. 11. Here, the three-dimensional elements 7 are connected by an interconnecting layer 22 which is made from a different, here more flexible material than the material from which the three-dimensional elements are provided.

FIGS. 12a and 12b depict each an example in which one layer, here layer 2 is provided with openings 21. Prior and/or during an impact, the three-dimensional elements 7 of the layer 3 extend into the openings and their overlap increases. In the present case only one three-dimensional element is depicted, but the person skilled in the art understands that one three-dimensional element is provided per opening. The layer 2 may be part of the structure to be reinforced, for example a body in white of a vehicle.

FIG. 13 shows yet another means 26 to connect the two layers 2, 3 prior to an impact. In the present case the connection means is a snap fit 26 with an elastic element 24, here at the first layer and an opening 25 at the second layer. During assembly, the elastic element snaps into the opening so that the two layers are connected.

The skilled person understands that the connection means can also be a friction- form- and/or force-fit.

FIGS. 14a and 14b show yet another embodiment of the present invention. In the present example the first and the second layer are produced as one single piece, preferably by blow-moulding. The two layers are here connected at their outer circumference, but could also be touching or being connected with the layers. In the present case, the three-dimensional objects are cone-shaped, wherein the cross-section of the cone is a square or a rectangle. They could also be conical or have any other tapered shape

FIG. 15 shows an embodiment in which the first layer 2 comprises adjacent to the three-dimensional elements 7 reinforcement elements 16, which reinforce a structure additionally to the layers 2 and 3 and/or in a different region. In the present case, the reinforcement elements 16 are ribs.

FIG. 16 shows a preferred embodiment of the present invention. During impact, the three dimensional elements 7 of the two layers 2, 3 are moved relative to each other and deform. During the deformation the three dimensional elements 7 interlock, so that after impact, preferably they cannot be separated from each other.

### REFERENCE SIGNS

1 Member
2 first layer
3 second layer
4 third layer
5 fourth layer
6 connecting means, connecting layer
7 three dimensional elements
8 outer circumference
9 structure
10 timeline
11 inner surface of three-dimensional elements 7
12 outer surface of three-dimensional elements 7
13 sidewall of the structure
14 area of discontinuity of the slope of the sidewall 13, step
15 recess
16 reinforcement element, rib
17 hollow space
18 unit of two layers
19 base
20 space
21 opening
22 interconnecting layer
23 groove
24 elastic element
25 opening
26 snap-fit

1. A member to absorb energy, particularly impact-energy comprising:
at least a first layer; and
a second layer;
wherein each layer comprises a multitude of interconnected three-dimensional elements and/or openings;
wherein for energy-dissipation: tithe three-dimensional elements of the first layer are inserted into the three-dimensional elements of the second layer and/or the openings and/or vice versa; and/or (ii) the three-dimensional elements of the first layer are inserted into a hollow space provided between two or more of the three-dimensional elements of the second layer and/or vice versa.

2. The member according to claim 1, wherein the three-dimensional elements are tapered, optionally with a non-constant taper, and optionally with one or more steps.

3. The member according to claim 2, wherein the three-dimensional elements of the layers have sidewalls and the sidewall of the three-dimensional elements of the first layer has, at least locally, a different shape and/or size than the sidewall of the three-dimensional elements of the second layer.

4. The member according to claim 3, wherein at least one of the first or second layer comprises a connecting means.

5. The member according to claim 3, wherein the thickness of the sidewall of the three-dimensional elements of at least one layer is not constant.

6. The member according to claim 2, wherein the three-dimensional elements of at least one layer comprise a reinforcement element.

7. The member according to claim 1, the first and the second layer are provided as one piece.

8. A system comprising a structure and a member according to claim 1.

9. The system according to claim 8, wherein the structure comprises a cavity in which the member is located.

10. The system according to claim 8, wherein at least one layer is attached to the structure.

11. A method to absorb energy, particularly impact energy, with, a member according to claim 1, wherein the three dimensional elements and/or the openings of the first and second layers are moved relative to one another, whereby friction between the three dimensional elements of the first and second layers takes place and the three dimensional elements and/or the openings of at least one layer are deformed plastically and/or elastically.

12. The method according to claim 11, wherein the three-dimensional elements and/or the openings are expanded and/or compressed and/or tangentially stressed, each reversibly and/or irreversibly.

13. The method according to claim 11, wherein the three-dimensional elements of the first layer are inserted into and/or between the three-dimensional elements and/or into the openings of the second layer.

14. The method according to claim 11, wherein the cross section of the three-dimensional elements and/or the openings of the layers is increased and/or decreased.

15. The method according to claim 11, wherein the three dimensional elements of two layers interlock during their plastic deformation.

16. The member according to claim 5, wherein the first and the second layer are provided as one piece.

17. The member according to claim 16, wherein the three-dimensional elements of at least one layer comprise a reinforcement element.

18. The member according to claim 1, wherein at least one of the first or second layer comprises a connecting means.

19. The method according to claim 14, wherein the three-dimensional elements of two layers interlock during their plastic deformation.

20. The member according to claim 1, wherein the three-dimensional elements are formed as truncated cones
